(19) United States
(12) Patent Application Publication
(10) Pub. No.: US 2017/0179498 A1
(43) Pub. Date: Jun. 22, 2017

(54) FUEL CELL GAS DIFFUSION LAYER, FUEL CELL, AND METHOD FOR MANUFACTURING FUEL CELL GAS DIFFUSION LAYER

(71) Applicant: Panasonic Intellectual Property Management Co., Ltd., Osaka (JP)

(72) Inventors: MASASHI SHOJI, Kyoto (JP); TSUTOMU KAWASHIMA, Nara (JP); SHINICHIRO IMURA, Hyogo (JP); KEIICHI KONDOU, Hyogo (JP)

(21) Appl. No.: 15/446,946

(22) Filed: Mar. 1, 2017

Related U.S. Application Data
(63) Continuation of application No. PCT/JP2015/004515, filed on Sep. 7, 2015.

(30) Foreign Application Priority Data
Oct. 17, 2014 (JP) 2014-213123

(51) Int. Cl. H01M 4/88; B29C 59/02

(52) U.S. Cl. CPC H01M 4/8807; B29C 59/026; H01M 2008/1095

(57) ABSTRACT

A fuel cell gas diffusion layer includes: a porous layer containing conductive particles and binder resin as primary components; a groove-shaped fluid flow path provided on one of main surfaces of the porous layer; and a conductive wire portion extending along the one of the main surfaces and a surface of the fluid flow path, the conductive wire portion being a layered collection of a plurality of conductive fibers which has pores.

### RELATED APPLICATIONS

This application is a Continuation of International Application No. PCT/JP2015/004515, filed on Sep. 7, 2015, which in turn claims priority from Japanese Patent Application No. 2014-213123, filed on Oct. 17, 2014, the contents of all of which are incorporated herein by reference in their entireties.

### BACKGROUND

1. Technical Field

The present disclosure relates to a fuel cell gas diffusion layer, a fuel cell including the fuel cell gas diffusion layer, and a method for manufacturing the fuel cell gas diffusion layer.

2. Description of the Related Art

A fuel cell is a device that generates electric energy from hydrogen and oxygen, and can achieve a high power generation efficiency. Since the fuel cell directly generates power without involving states as thermal energy or kinetic energy that are involved in the conventional power generation scheme, the fuel cell has main characteristics such as high power generation efficiency with a small size, and less influence on the environment due to less emission of nitrogen compound and other harmful substances, less noise and less vibration. As described above, the fuel cell achieves the effective use of the chemical energy of fuel and has the environmentally friendly characteristic, and thus is expected as an energy supplying system for the twenty-first century. For this reason, the fuel cell has been attracting attention as a promising novel power generation system for use in space, an automobile, and a mobile instrument, and for various kinds of usages ranging from large-scale power generation to small-scale power generation. Accordingly, the technological development of the fuel cell has been fully in progress for practice use.

International Publication No. WO 11/045889 discloses a fuel cell including a catalyst layer, a gas diffusion layer, and a separator that are sequentially stacked on both surfaces of a polymer electrolyte film. The gas diffusion layer of this fuel cell is a conductive carbon sheet including a fluid flow path in a surface of the sheet in contact with the separator.

### SUMMARY

An aspect of the present disclosure is a fuel cell gas diffusion layer. The fuel cell gas diffusion layer includes: a porous layer containing conductive particles and binder resin as primary components; a groove-shaped fluid flow path provided on one of main surfaces of the porous layer; and a conductive wire portion extending along the one of the main surfaces and a surface of the fluid flow path, the conductive wire portion being a layered collection of a plurality of conductive fibers which has pores.

Another aspect of the present disclosure is a fuel cell. The fuel cell includes: a membrane electrode assembly including an electrolyte film, an anode catalyst layer disposed on one of surfaces of the electrolyte film, and a cathode catalyst layer disposed on the other surface of the electrolyte film; an anode gas diffusion layer disposed on the membrane electrode assembly at a side of the anode catalyst layer; and a cathode gas diffusion layer disposed on the membrane electrode assembly at a side of a the cathode catalyst layer. At least one of the anode gas diffusion layer and the cathode gas diffusion layer is constituted by the fuel cell gas diffusion layer according to the above-described aspect.

Another aspect of the present disclosure is a method for manufacturing a fuel cell gas diffusion layer. The method for manufacturing a fuel cell gas diffusion layer includes: preparing a porous sheet containing at least conductive particles; forming a layer of conductive fibers on one of main surfaces of the porous sheet; deforming the porous sheet and the layer of conductive fibers through heating and pressurization so as to form a porous layer including a groove-shaped fluid flow path on one of main surfaces of the porous layer and so as to form a conductive wire portion extending along the one of the main surfaces of the porous layer and a surface of the fluid flow path, the conductive wire portion being configured by the layer of the conductive fibers which has pores.

The present disclosure can achieve improved conductivity of a fuel cell gas diffusion layer.

### BRIEF DESCRIPTION OF THE DRAWINGS

FIG. 1 is a perspective view schematically illustrating the structure of a fuel cell according to an exemplary embodiment;

FIG. 2 is a schematic sectional view taken along line II-II in FIG. 1;

FIG. 3A is a perspective view schematically illustrating an exemplary structure of a conductive wire portion;

FIG. 3B is a sectional view schematically illustrating another exemplary structure of the conductive wire portion;

FIGS. 4A to 4D are each a sectional view schematically illustrating the process of an exemplary method for manufacturing a fuel cell gas diffusion layer;

FIGS. 5A to 5B are each a sectional view schematically illustrating the process of an exemplary method for manufacturing a fuel cell gas diffusion layer; and

FIGS. 6A to 6D are each a sectional view schematically illustrating the process of another exemplary method for manufacturing a fuel cell gas diffusion layer.

### DETAILED DESCRIPTION OF EMBODIMENT

Detailed studies performed on the fuel cell described above by the inventor of the present disclosure, have found that the conductivity of the conventional fuel cell gas diffusion layer can be further improved.

The present disclosure is achieved based on this finding, and provides a technology for improving the conductivity of the fuel cell gas diffusion layer.

An exemplary embodiment of the present disclosure will be described below with reference to the accompanying drawings. In all drawings, any identical components are denoted by an identical reference sign, and any duplicate description thereof will be omitted as appropriate. The exemplary embodiment is not intended to limit the disclosure but is merely exemplary, and all characteristics and any combination thereof described in the exemplary embodiment do not necessarily represent essential elements of the disclosure.

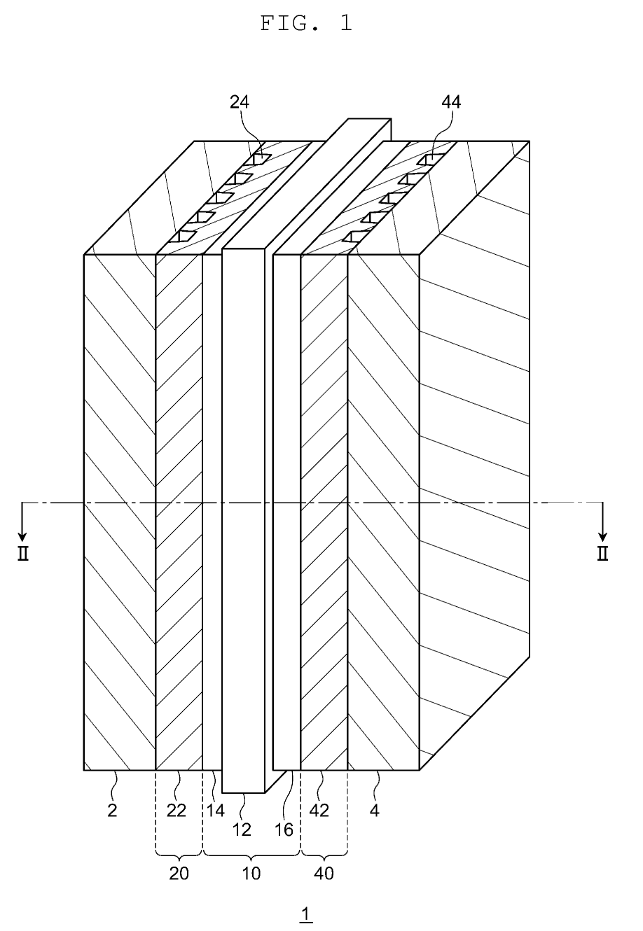

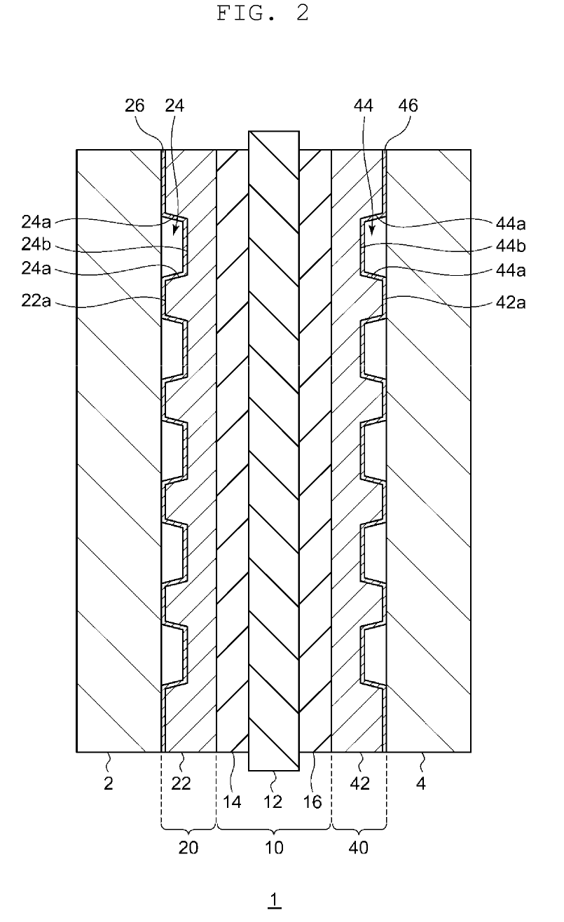

FIG. 1 is a perspective view schematically illustrating the structure of a fuel cell according to the exemplary embodiment. FIG. 2 is a schematic sectional view taken along line II-II in FIG. 1. In FIG. 1, illustrations of conductive wire portions 26, 46 are omitted. This fuel cell 1 according to the present exemplary embodiment includes membrane electrode assembly 10 shaped in a substantially flat plate, and anode gas diffusion layer 20 and cathode gas diffusion layer 40 as gas diffusion layers for a fuel cell. Hereinafter, when not needed to be distinguished, anode gas diffusion layer 20 and cathode gas diffusion layer 40 are collectively referred to as the gas diffusion layer for a fuel cell. Anode gas diffusion layer 20 and cathode gas diffusion layer 40 are provided such that one of main surfaces of anode gas diffusion layer 20 and one of main surfaces of cathode gas diffusion layer 40 face each other with membrane electrode assembly 10 interposed between anode gas diffusion layer 20 and cathode gas diffusion layer 40. Separator 2 is provided on the other of the main surfaces of anode gas diffusion layer 20, which is at a side farther from membrane electrode assembly 10. Separator 4 is provided on the other of the main surfaces of cathode gas diffusion layer 40, which is at a side farther from membrane electrode assembly 10. In the present exemplary embodiment, description is made on one set of membrane electrode assembly 10, anode gas diffusion layer 20, and cathode gas diffusion layer 40, but a plurality of the sets may be stacked with separators 2 and 4 interposed between the sets, thereby serving as a fuel cell stack.

Membrane electrode assembly 10 includes electrolyte film 12, anode catalyst layer 14 disposed on one of surfaces of electrolyte film 12, and cathode catalyst layer 16 disposed on the other surface of electrolyte film 12.

Electrolyte film 12 has good ion conductivity in a wet state, and serves as an ion exchange membrane that allows protons to move between anode catalyst layer 14 and cathode catalyst layer 16. Electrolyte film 12 is formed of a solid polymer material such as fluorine-containing polymer or non-fluorine polymer. Examples of the material of electrolyte film 12 include sulfonic acid type perfluorocarbon polymer, polysulfone resin, and perfluorocarbon polymer including phosphonate group or carboxylic acid group. Examples of sulfonic acid type perfluorocarbon polymer includes, Nafion (manufactured by Du Pont; registered trademark) 112. Examples of non-fluorine polymer include sulfonated aromatic polyether ether ketone and polysulfone. Electrolyte film 12 has a thickness of, for example, 10 μm to 200 μm inclusive.

Anode catalyst layer 14 and cathode catalyst layer 16 each include ion exchange resin and a catalyst particle, and in some cases include carbon particle that supports catalyst particle. The ion exchange resin included in anode catalyst layer 14 and cathode catalyst layer 16 connects the catalyst particle and electrolyte film 12 to transfer a proton between the catalyst particle and electrolyte film 12. The ion exchange resin may be formed of a polymer material similarly to the polymer material of electrolyte film 12. Examples of the catalyst particle include catalyst metals such as alloys or singles selected from the group consisting of Sc, Y, Ti, Zr, V, Nb, Fe, Co, Ni, Ru, Rh, Pd, Pt, Os, Ir, lanthanoid series elements, and actinoid series elements. The carbon particle may be, for example, acetylene black, Ketjen black, or carbon nano tube. Anode catalyst layer 14 and cathode catalyst layer 16 each has a thickness of, for example, 10 μm to 40 μm inclusive.

Anode gas diffusion layer 20 is disposed on anode catalyst layer 14 of membrane electrode assembly 10. Anode gas diffusion layer 20 includes porous layer 22, fluid flow path 24, and conductive wire portion 26. Anode gas diffusion layer 20 has a thickness of, for example, 50 μm to 500 μm inclusive. Porous layer 22 contains at least one of a conductive fiber and a conductive particle (in other words, contains at least conductive particles), and includes a large number of fine voids. Porous layer 22 contains binder resin that binds the contained conductive fibers and/or conductive particles to each other. Porous layer 22 has a thickness of, for example, 40 μm to 490 μm inclusive.

The conductive fibers may be, for example, carbon fibers such as polyacrylonitrile carbon fibers, rayon carbon fibers, pitch carbon fibers, or carbon nano tubes, metal fibers, or metal-carbon composite material such as carbon-coated metal fibers. Each conductive fiber preferably has a length of 30 μm or longer. When the length of each conductive fiber is 30 μm or longer, increase in the number of contact points between the conductive fibers is prevented, thereby preventing reduction in the conductivity and tensile strength of porous layer 22. When the length of each conductive fiber is 30 μm or longer, porous layer 22 more reliably have a desired gas diffusion property.

The length of each conductive fiber is measured as follows. Specifically, the porous layer is cut to form a sectional surface. This sectional surface is polished, and then an image of the sectional surface is captured by a scanning electron microscope (SEM). Then, the length of the conductive fiber is measured in the obtained image of the sectional surface. Another measuring method is performed as follows. Specifically, part of the porous layer is cut out and put into a solvent that dissolves thermoplastic resin. Accordingly, thermoplastic resin in porous layer 22 is dissolved. Then, the conductive fibers separated from each other are recovered from the solvent through the well-known operation such as filtration. For example, 400 of the separated conductive fibers are randomly extracted, and the length of each conductive fiber is measured by using an optical microscope or a SEM. The conductive fibers may be separated by a method without a solvent that dissolves thermoplastic resin. In this method, the part of porous layer 22 thus cut out is heated, for example, at a temperature of 500° C. for 30 minutes. Accordingly, the thermoplastic resin is burnt away to obtain the conductive fibers separated from each other.

The conductive particles may be, for example, carbon particles of carbon black, artificial graphite, natural graphite, or expanded graphite, or metal particles. The conductive particles have an average particle diameter of, for example, 0.01 μm to 50 μm inclusive for primary particles. The binder resin may be fluorine resin such as PTFE (polytetrafluoro ethylene), PFA (tetrafluoro ethylene-perfluoro alkyl vinyl ether copolymer), FEP (tetrafluoro ethylene-hexafluoropropylene copolymer), or ETFE (tetrafluoro ethylene-ethylene copolymer).

Fluid flow path 24 has a groove shape and is provided on one of main surfaces 22a of porous layer 22. Fluid flow path 24 is a recess provided on the main surface of porous layer 22. Fluid flow path 24 is disposed on a side of separator 2, and serves as a flow path for fuel gas. Fuel gas such as hydrogen gas is distributed into fluid flow path 24 through a fuel supply manifold (not illustrated), and is supplied from fluid flow path 24 to anode catalyst layer 14 of membrane electrode assembly 10 through porous layer 22. Fluid flow path 24 has, for example, a depth of 30 μm to 450 μm inclusive and a width of 100 μm to 1000 μm inclusive, and the distance between adjacent fluid flow paths 24 is 100 um to 1000 μm inclusive. In the present exemplary embodiment, five fluid flow paths 24 are provided, but the number of fluid flow paths 24 is not particularly limited and may be set as appropriate in accordance with, for example, the dimensions of anode gas diffusion layer 20 and fluid flow paths 24.

Conductive wire portion 26 extends along a shape constituted by one of main surfaces 22a of porous layer 22 and surfaces of fluid flow paths 24. Conductive wire portion 26 serves as a conduction path through which an electron generated in anode catalyst layer 14 flows from anode catalyst layer 14 to separator 2. When conductive wire portion 26 is provided, improved conductivity of anode gas diffusion layer 20 can be obtained. Conductive wire portion 26 has a thickness of, for example, 1 μm to 40 μm inclusive.

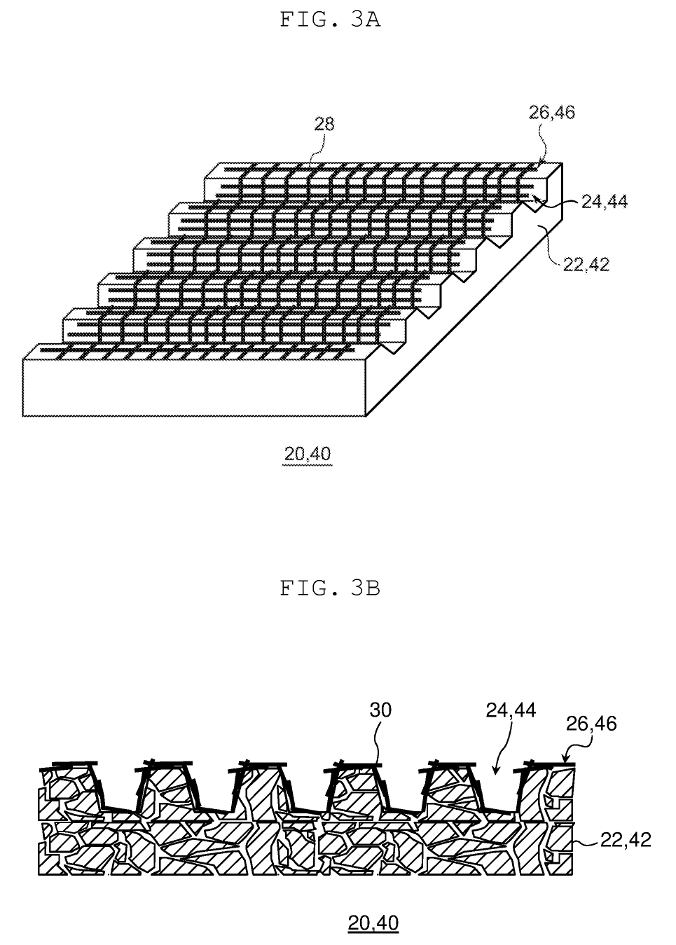

Conductive wire portion 26 is provided partially covering main surface 22a of porous layer 22 and the surfaces of fluid flow paths 24 to suppress degradation of the gas diffusion property of anode gas diffusion layer 20. FIG. 3A is a perspective view schematically illustrating an exemplary structure of the conductive wire portion, and FIG. 3B is a sectional view schematically illustrating another exemplary structure of the conductive wire portion. As illustrated in, for example, FIG. 3A, conductive wire portion 26 is mesh member 28 as a plurality of conductive wires connected with each other in a mesh. The material of mesh member 28 may be, for example, carbon fibers such as polyacrylonitrile carbon fibers, rayon carbon fiber, pitch carbon fiber, or carbon nano tubes, metal fibers, or metal-carbon composite material such as carbon-coated metal fibers. When conductive wire portion 26 is configured by mesh member 28, improved electric conductivity of anode gas diffusion layer 20 can be obtained while degradation of the gas diffusion property of anode gas diffusion layer 20 is suppressed.

As illustrated in, for example, FIG. 3B, conductive wire portion 26 is configured by conductive fibers 30. Conductive fibers 30 may be, for example, carbon fibers such as polyacrylonitrile carbon fibers, rayon carbon fibers, pitch carbon fibers, or carbon nano tubes, metal fibers, or metal-carbon composite material such as carbon-coated metal fibers. In the example illustrated in FIG. 3B, porous layer 22 contains the conductive particles and the binder resin as primary components, and a layer of conductive fibers 30 is formed on the main surface of porous layer 22. The layer of conductive fibers 30 is a layered collection of a plurality of individual conductive fibers (conductive wires), and has a large number of fine pores in the layer. With this configuration, improved electric conductivity of anode gas diffusion layer 20 can be obtained while degradation of the gas diffusion property of anode gas diffusion layer 20 is suppressed.

Conductive fibers 30 configuring conductive wire portion 26 illustrated in FIG. 3B each preferably have a length shorter than the depth of each fluid flow path 24 and smaller than a minimum width (for example, the length of bottom surface 24b in FIG. 2) of fluid flow path 24. This configuration allows formation of conductive wire portion 26 having a desirably designed shape (shape along the surfaces of the fluid flow path and the rib portion) when the depth and width of fluid flow path 24 are small or when the height and width of a rib portion (protrusion formed between adjacent fluid flow paths 24) are small. The configuration can also prevent change of the characteristics (uniform distribution property and gas diffusion property) of conductive wire portion 26 caused by tangled conductive fibers 30. Conductive wire portion 26 illustrated in FIG. 3B preferably contains binder resin that binds the conductive fibers each other, has a contact angle of 130° or larger, and has a water-repellent property. Accordingly, generated water clogging in conductive wire portion 26 is avoided to achieve an improved gas diffusion performance. The binder resin may be what is provided in the description of porous layer 22.

The description will be given of another characteristic of the configuration in FIG. 3B. Conductive wire portion 26 preferably has a density smaller than the density of porous layer 22. This can reduce degradation of the gas diffusion property near a surface of anode gas diffusion layer 20. The proportion of the conductive particles in porous layer 22 is preferably 50 wt % or larger. This enables fabrication and shaping of the fine rib portion (a manufacturing method of the fine rib portion will be described later). The proportion of conductive fibers 30 in conductive wire portion 26 is preferably 70 wt % or larger. With this condition, electric resistance can be reduced in a direction along the shapes of the surfaces of fluid flow paths 24.

In the configuration in FIG. 3B, each fluid flow path 24 preferably has a width of 0.1 mm to 1.0 mm inclusive at the middle in the depth direction of fluid flow path 24. This is because water clogging is likely to occur in the fluid flow path when the width of fluid flow path 24 is 0.1 mm or smaller, and the gas diffusion property decreases between fluid flow paths 24 due to a longer distance required between fluid flow paths 24 when the width exceeds 1.0 mm. Carbon nano tubes are preferably used as conductive fibers 30. Carbon nano tubes have an excellent shape fabrication property and can provide a low resistance characteristic of conductive wire portion 26, which is an advantageous effect.

Conductive wire portion 26 is preferably made of a material, such as gold (Au), having a conductivity higher than the conductivities of the conductive fibers and the conductive particles included in porous layer 22. With this configuration, anode gas diffusion layer 20 can have a further improved conductivity. When porous layer 22 includes conductive fibers, these conductive fibers may be used also as conductive fibers 30 configuring conductive wire portion 26. In this case, any increase in the number of components and the number of manufacturing processes can be avoided when conductive wire portion 26 is provided.

The surface of each fluid flow path 24 includes bottom surface 24b, and two side surfaces 24a positioned on both sides of bottom surface 24b. In conductive wire portion 26, at least part of the plurality of conductive wires preferably extends, on at least one of side surfaces 24a, in the direction of a line connecting bottom surface 24b and main surface 22a of porous layer 22. The conductive wires of conductive wire portion 26 also preferably extend, on side surfaces 24a of fluid flow path 24, from bottom surface 24b of fluid flow path 24 toward main surface 22a of porous layer 22. In addition, the conductive wires of conductive wire portion 26 preferably extend from bottom surface 24b to main surface 22a on side surfaces 24a. Main surface 22a of porous layer 22 is a region of anode gas diffusion layer 20 in contact with separator 2. Bottom surface 24b of fluid flow path 24 is a region including a deepest part of fluid flow path 24 and having a predetermined width, or a region substantially parallel to main surface 22a. Side surfaces 24a of fluid flow path 24 are regions between main surface 22a and bottom surface 24b.

Anode gas diffusion layer 20 is in contact with separator 2 at main surface 22a of porous layer 22, and bottom surface 24b and side surfaces 24a of fluid flow path 24 are not in contact with separator 2. Thus, movement of an electron is hindered in part of anode gas diffusion layer 20 not in contact with separator 2, in particular, in a region in which bottom surface 24b of fluid flow path 24 is between membrane electrode assembly 10 and separator 2. However, since bottom surface 24b and main surface 22a of porous layer 22 are electrically connected with each other through conductive wire portion 26 provided on side surfaces 24a of fluid flow path 24, a conduction path from bottom surface 24b of fluid flow path 24 to main surface 22a of porous layer 22 can have a reduced resistance. With this configuration, the conductivity of anode gas diffusion layer 20 can be more efficiently improved.

In conductive wire portion 26, at least part of the plurality of conductive wires preferably extends, on bottom surface 24b of fluid flow path 24, in the direction of a line connecting bottom surface 24b and each side surface 24a. The conductive wires of conductive wire portion 26 also preferably extend toward side surfaces 24a on both sides on bottom surface 24b of fluid flow path 24. In addition, the conductive wires of conductive wire portion 26 preferably extend one of side surfaces 24a to the other side surface 24a on bottom surface 24b. Thus, a conduction path from bottom surface 24b to each side surface 24a of fluid flow path 24 can have a reduced resistance. Accordingly, an electron is more likely to flow from bottom surface 24b of fluid flow path 24 to main surface 22a of porous layer 22. With this configuration, the conductivity of anode gas diffusion layer 20 can be more efficiently improved.

In conductive wire portion 26, at least part of the plurality of conductive wires preferably extends, on main surface 22a of porous layer 22, in the direction of a line connecting main surface 22a and each side surface 24a of fluid flow path 24. The conductive wires of conductive wire portion 26 also preferably extend toward side surfaces 24a of fluid flow path 24 on main surface 22a of porous layer 22. In addition, the conductive wires of conductive wire portion 26 preferably extend from one of side surfaces 24a to the other side surface 24a on main surface 22a. Thus, a conduction path from each side surface 24a of fluid flow path 24 to main surface 22a can have a reduced resistance. Accordingly, an electron is more likely to flow from bottom surface 24b of fluid flow path 24 to main surface 22a of porous layer 22. With this configuration, the conductivity of anode gas diffusion layer 20 can be more efficiently improved.

When conductive wire portion 26 is configured by mesh member 28, the conductive wires as a single unit extend from bottom surface 24b of fluid flow path 24 to main surface 22a of porous layer 22 through side surfaces 24a (FIG. 2 illustrates a sectional surface of a single conductive wire as conductive wire portion 26). With this configuration, the conductivity of anode gas diffusion layer 20 can be more efficiently improved.

As illustrated in FIGS. 1 and 2, cathode gas diffusion layer 40 is disposed on cathode catalyst layer 16 of membrane electrode assembly 10. Cathode gas diffusion layer 40 includes porous layer 42, fluid flow path 44, and conductive wire portion 46. Cathode gas diffusion layer 40 has a thickness of, for example, 50 μm to 500 μm inclusive.

Porous layer 42 contains at least one of a conductive fiber and a conductive particle (in other words, contains at least conductive particles). Porous layer 42 has configuration same as the configuration of porous layer 22 of anode gas diffusion layer 20, and thus a detailed description thereof will be omitted. Fluid flow path 44 has a groove shape and is provided on one of main surfaces 42a of porous layer 42. Fluid flow path 44 is a recess provided on the main surface of porous layer 42. Fluid flow path 44 is disposed on separator 4, and serves as a flow path for oxidant gas. Oxidant gas such as air is distributed to fluid flow path 44 through an oxidant supply manifold (not illustrated), and is supplied from fluid flow path 44 to cathode catalyst layer 16 of membrane electrode assembly 10 through porous layer 42. Fluid flow path 44 also serves as a drainage path for water generated in cathode catalyst layer 16. For example, the dimensions and the number of fluid flow paths 44 are same as the dimensions and the number of fluid flow paths 24 of anode gas diffusion layer 20.

Conductive wire portion 46 extends along a shape constituted by one of main surfaces 42a of porous layer 42 and surfaces of fluid flow paths 44. Conductive wire portion 46 serves as a conduction path from separator 4 to cathode catalyst layer 16 for an electron moving from anode catalyst layer 14. When conductive wire portion 46 is provided, improved conductivity of cathode gas diffusion layer 40 can be obtained. Conductive wire portion 46 has a thickness of, for example, 1 μm to 40 μm inclusive.

Conductive wire portion 46 is provided partially covering main surface 42a of porous layer 42 and the surfaces of fluid flow paths 44 to suppress degradation of the gas diffusion property of cathode gas diffusion layer 40. As illustrated in, for example, FIG. 3A, conductive wire portion 46 is conductive mesh member 28. As illustrated in, for example, FIG. 3B, conductive wire portion 46 is configured by conductive fibers 30. With this configuration, the suppression of degradation of the gas diffusion property and improvement of the electric conductivity of cathode gas diffusion layer 40 can be both achieved. Conductive wire portion 46 illustrated in FIG. 3B may have characteristics (for example, the length of each conductive fiber, the contact angle, the density, and the proportion of the conductive fibers) similarly to the characteristics of conductive wire portion 26 illustrated in FIG. 3B. Porous layer 42 illustrated in FIG. 3B can have characteristics (for example, the proportion of the conductive particles) similarly to the characteristics of porous layer 22 illustrated in FIG. 3B. Conductive wire portion 46 is more preferably made of a material having a conductivity higher than the conductivities of the conductive fibers and conductive particles included in porous layer 42. When porous layer 42 includes conductive fibers, these conductive fibers may be also used as conductive fibers 30 configuring conductive wire portion 46.

Similarly to conductive wire portion 26 in anode gas diffusion layer 20, in conductive wire portion 46, at least part of the plurality of conductive wires preferably extends, on at least one of side surfaces 44a, in the direction of a line connecting bottom surface 44b and main surface 42a of porous layer 42. The conductive wires also preferably extend from bottom surface 44b of fluid flow path 44 toward main surface 42a of porous layer 42 on each side surface 44a of fluid flow path 44. In addition, the conductive wires preferably extend from bottom surface 44b to main surface 42a on side surface 44a.

In conductive wire portion 46, at least part of the plurality of conductive wires preferably extends, on bottom surface 44b of fluid flow path 44, in the direction of a line connecting bottom surface 44b and each side surface 44a. The conductive wires also preferably extend toward side surfaces 44a on both sides on bottom surface 44b of fluid flow path 44. In addition, the conductive wires preferably extend one of side surfaces 44a to the other side surface 44a on bottom surface 44b.

In conductive wire portion 46, at least part of the plurality of conductive wires preferably extends, on main surface 42a of porous layer 42, in the direction of a line connecting main surface 42a and each side surface 44a of fluid flow path 44. The conductive wires also preferably extend toward each side surface 44a of fluid flow path 44 on main surface 42a of porous layer 42. In addition, the conductive wires preferably extend from one of side surfaces 44a to the other side surface 44a on main surface 42a. Definitions of main surface 42a of porous layer 42, and side surfaces 44a and bottom surface 44b of fluid flow path 44 are the same as definitions of main surface 22a of porous layer 22, and side surfaces 24a and bottom surface 24b of fluid flow path 24. With this configuration, similarly to conductive wire portion 26, the conductivity of cathode gas diffusion layer 40 can be more efficiently improved.

A stacked structure of anode catalyst layer 14 and anode gas diffusion layer 20 is also referred to as an anode, and a stacked structure of cathode catalyst layer 16 and cathode gas diffusion layer 40 is also referred to as a cathode.

A reaction described below occurs in solid polymer fuel cell 1 described above. Specifically, when hydrogen gas as fuel gas is supplied to anode catalyst layer 14 through anode gas diffusion layer 20, a reaction represented by Formula (1) below occurs in anode catalyst layer 14, whereby hydrogen is decomposed into protons and electrons. The protons move toward cathode catalyst layer 16 in electrolyte film 12. The electron moves to an external circuit (not illustrated) through anode gas diffusion layer 20 and separator 2, and then flows from the external circuit into cathode catalyst layer 16 through separator 4 and cathode gas diffusion layer 40. When air as oxidant gas is supplied to cathode catalyst layer 16 through cathode gas diffusion layer 40, a reaction represented by Formula (2) below occurs in cathode catalyst layer 16, oxygen in the air becomes water through reaction with protons and electrons. As a result, electrons flow from the anode toward the cathode through the external circuit, thereby generating electrical power.

Anode catalyst layer 14: H₂→2H⁺+2e⁻ (1)

Cathode catalyst layer 16: 2H⁺+(1/2)O₂+2e⁻→H₂O (2)

### [Process of Manufacturing a Fuel Cell Gas Diffusion Layer]

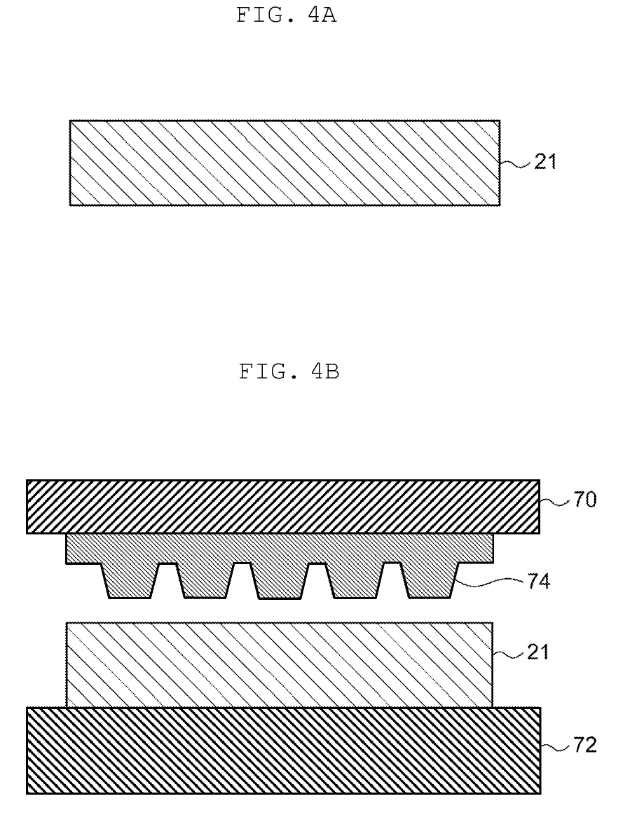

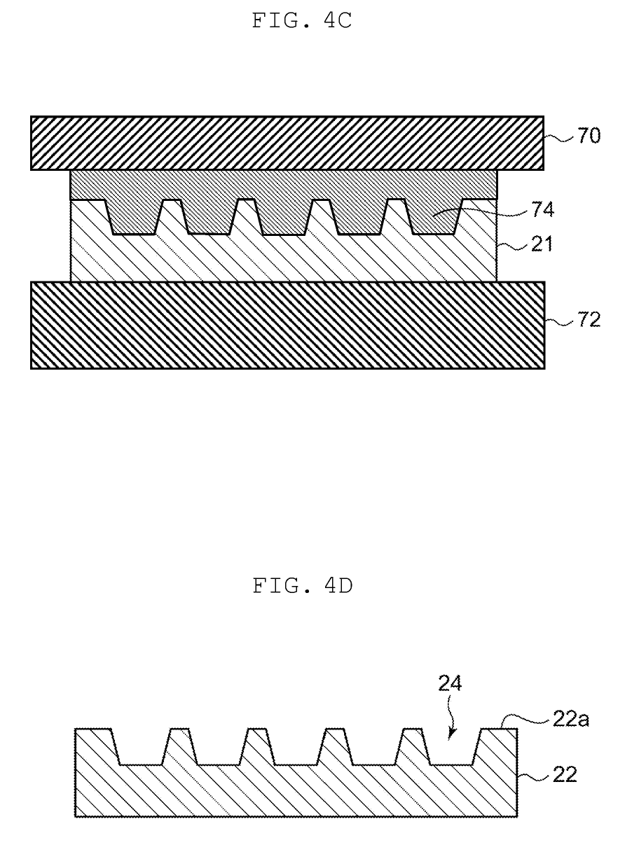

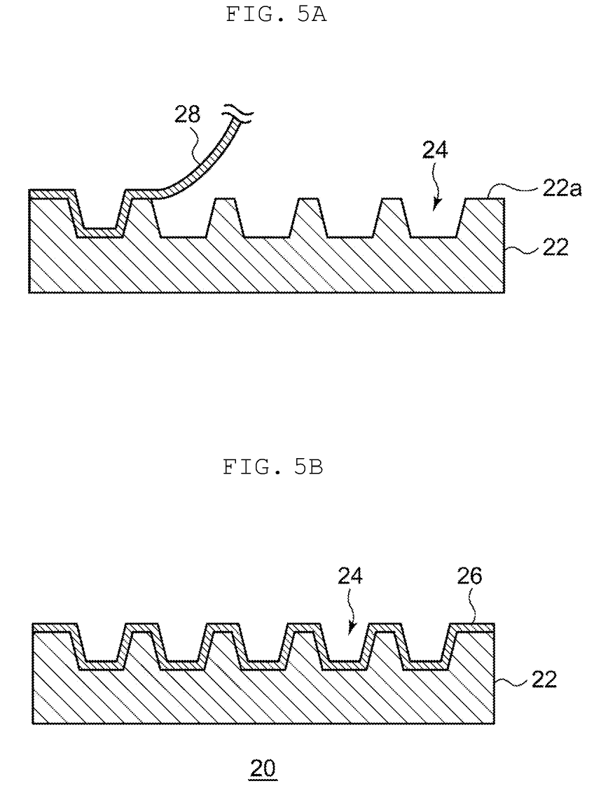

The description will be given of an exemplary method for manufacturing a fuel cell gas diffusion layer according to an exemplary embodiment. FIGS. 4A to 4D and 5A to 5B are each a sectional view schematically illustrating the process of an exemplary method for manufacturing a fuel cell gas diffusion layer. In this example, conductive wire portion 26 is formed as mesh member 28. The method for manufacturing a fuel cell gas diffusion layer will be described below with reference to an example with anode gas diffusion layer 20.

First, as illustrated in FIG. 4A, porous sheet 21 is prepared. Porous sheet 21 contains conductive fibers and/or conductive particles (in other words, at least conductive particles), and binder resin. Next, as illustrated in FIG. 4B, porous sheet 21 is disposed between first mold 70 and second mold 72. First mold 70 is provided with protrusions 74 corresponding to the shapes of fluid flow paths 24. Second mold 72 facing protrusions 74 has a flat surface.

Subsequently, as illustrated in FIG. 4C, first mold 70 and second mold 72 are moved to make predetermined shape, and porous sheet 21 is heated and pressurized at predetermined temperature and pressure. The temperature and pressure at the molding are, for example, 100° C. to 200° C., and 2 MPa to 3 MPa, respectively. In this manner, porous sheet 21 is deformed to match the shape of protrusion 74. After a predetermined time has elapsed, first mold 70 and second mold 72 are released. As a result, as illustrated in FIG. 4D, porous layer 22 provided with fluid flow paths 24 on one of main surfaces 22a is formed.

Subsequently, as illustrated in FIG. 5A, main surface 22a of porous layer 22 and the surfaces of fluid flow paths 24 (in other words, side surface 24a and bottom surface 24b illustrated in FIG. 2) are covered with mesh member 28. Preferably, after mesh member 28 is placed along main surface 22a of porous layer 22 and the surfaces of fluid flow paths 24, porous layer 22 and conductive wire portion 26 are pressed and fixed to each other through heating and pressurization. As illustrated in FIG. 5B, the above-described process obtains anode gas diffusion layer 20 including porous layer 22 provided with fluid flow paths 24 formed on one main surface 22a and conductive wire portion 26 extending along main surface 22a of porous layer 22 and the surfaces of fluid flow paths 24.

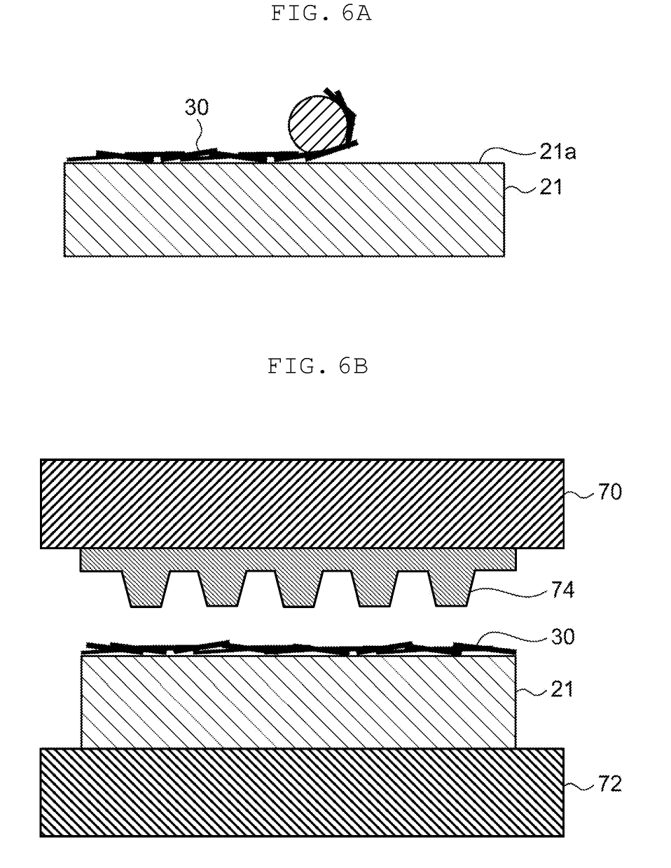

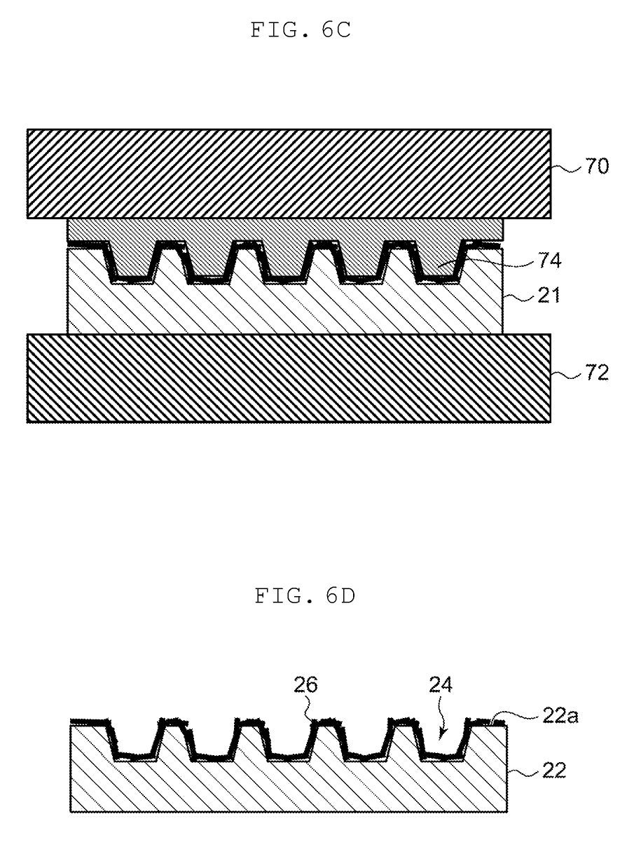

The description will be given of another exemplary method for manufacturing a fuel cell gas diffusion layer according to an exemplary embodiment. FIGS. 6A to 6D are each a sectional view schematically illustrating the process of another exemplary method for manufacturing a fuel cell gas diffusion layer. In this example, conductive wire portion 26 is formed as conductive fibers 30. The method for manufacturing a fuel cell gas diffusion layer will be described below with reference to an example with anode gas diffusion layer 20.

First, as illustrated in FIG. 6A, porous sheet 21 is prepared. Porous sheet 21 contains conductive fibers and/or conductive particles (in other words, at least conductive particles), and binder resin. In addition, a slurry of conductive fibers 30 and binder resin is prepared. Then, this slurry is applied to main surface 21a of porous sheet 21. The application of the slurry may be performed by the conventionally well-known method such as a roll coating method and a spray application method. In this manner, a layer of conductive fibers 30 is formed on main surface 21a of porous sheet 21.

Subsequently, as illustrated in FIG. 6B, porous sheet 21 is disposed between first mold 70 and second mold 72. Porous sheet 21 is disposed such that the layer of conductive fibers 30 faces first mold 70. First mold 70 is provided with protrusions 74 corresponding to the shapes of fluid flow paths 24. Second mold 72 facing protrusions 74 has a flat surface.

Subsequently, as illustrated in FIG. 6C, first mold 70 and second mold 72 are moved to make predetermined shape, and porous sheet 21 and the layer of conductive fibers 30 are heated and pressurized at predetermined temperature and pressure. The temperature and pressure at the molding are, for example, 100° C. to 200° C., and 3 MPa to 4 MPa, respectively. In this manner, porous sheet 21 and the layer of conductive fibers 30 are deformed to match the shape of protrusion 74. The proportion of the conductive particles in porous sheet 21 is preferably 50 wt % or larger. This condition enables fabrication and shaping of a fine rib portion. After a predetermined time has elapsed, first mold 70 and second mold 72 are released. As illustrated in FIG. 6D, the above-described process obtains anode gas diffusion layer 20 including porous layer 22 provided with fluid flow paths 24 on one main surface 22a and conductive wire portion 26 extending along main surface 22a of porous layer 22 and the surfaces of fluid flow paths 24. Each conductive fiber 30 preferably has a length smaller than the depth of fluid flow path 24 and smaller than the minimum width of fluid flow path 24. This configuration allows formation of conductive wire portion 26 having a desirably designed shape.

When conductive wire portion 26 is formed of the conductive fibers included in porous layer 22, anode gas diffusion layer 20 can be manufactured as follows for example. Specifically, first a porous sheet containing conductive fibers and binder resin is prepared. This porous sheet may contain conductive particles, but is preferably made of only conductive fibers and binder resin on at least one of main surfaces. Then, similarly to the above-described manufacturing method, after the porous sheet is set between first mold 70 and second mold 72, and then first mold 70 and second mold 72 are moved to make predetermined shape, the porous sheet is heated and pressurized. In this manner, conductive wire portion 26 is formed simultaneously with formation of fluid flow paths 24 in the porous sheet. The above-described process manufactures anode gas diffusion layer 20 in which conductive fibers are used in porous layer 22 and conductive wire portion 26.

As described above, the fuel cell gas diffusion layer according to the present exemplary embodiment includes porous layers 22, 42, fluid flow paths 24, 44, main surfaces 22a, 42a of porous layers 22, 42, and conductive wire portions 26, 46 extending along the surfaces of fluid flow paths 24, 44. In this manner, when conductive wire portions 26, 46 are provided parallel to outlines of the fuel cell gas diffusion layers on the separators, the fuel cell gas diffusion layers can have improved conductivities, and accordingly, the electric conductivity is improved between separators 2, 4 and membrane electrode assembly 10 through the fuel cell gas diffusion layers. Consequently, the performance of fuel cell 1 can be improved. In addition, when conductive wire portions 26, 46 are provided, the thermal conductivities of the fuel cell gas diffusion layers can be improved, thereby further improving the performance of fuel cell 1.

Moreover, since the electric conductivities of the fuel cell gas diffusion layers can be improved, the freedom of designing the shapes of the fuel cell gas diffusion layers can be improved. For example, when the depths of fluid flow paths 24, 44 are reduced and the widths of fluid flow paths 24, 44 are increased, an interval between adjacent fluid flow paths 24 or adjacent fluid flow paths 44 is reduced. As a result, electric conductivities between the fuel cell gas diffusion layers and separators 2, 4 decrease. The interval between adjacent fluid flow paths 24 or adjacent fluid flow paths 44 can be increased to prevent reduction of the electric conductivities between the fuel cell gas diffusion layers and separators 2, 4. However, when this interval is increased, sectional areas of fluid flow paths 24, 44 are reduced, which causes increased pressure loss through fluid flow paths 24, 44.

However, reduction of the increased pressure loss through fluid flow paths 24, 44 requires increase in the depths of fluid flow paths 24, 44 to maintain the sectional areas of fluid flow paths 24, 44. The increase in the depths of fluid flow paths 24, 44 makes it difficult to reduce the thicknesses of the fuel cell gas diffusion layers. However, the electric conductivities of the fuel cell gas diffusion layers according to the present exemplary embodiment can be improved. Thus, reduction in the electric conductivities between the fuel cell gas diffusion layers and separators 2, 4 can be prevented when the depths of fluid flow paths 24, 44 are reduced and the widths of fluid flow paths 24, 44 are increased so that the interval between adjacent fluid flow paths 24 or adjacent fluid flow paths 44 are reduced. In this manner, the thickness of the fuel cell gas diffusion layers can be reduced without increasing electric resistances of the fuel cell gas diffusion layers and without increasing a pressure loss of pressurized introduction gas, which leads to reduction of the volume of fuel cell 1.

The present disclosure is not limited to the above-described exemplary embodiments, but a modification involving various design changes may be added to the exemplary embodiment based on the knowledge of the skilled person in the art. The exemplary embodiment to which such a modification is added is included in the scope of the present disclosure.

In the exemplary embodiments described above, anode gas diffusion layer 20 and cathode gas diffusion layer 40 include porous layers 22, 42, fluid flow paths 24, 44, and conductive wire portions 26, 46. However, the present disclosure is not particularly limited thereto, but only one of anode gas diffusion layer 20 and cathode gas diffusion layer 40 may include the above-described configuration.

What is claimed is:

1. A fuel cell gas diffusion layer comprising:
a porous layer containing conductive particles and binder resin as primary components;
a groove-shaped fluid flow path provided on one of main surfaces of the porous layer; and
a conductive wire portion extending along the one of the main surfaces and a surface of the fluid flow path, the conductive wire portion being a layered collection of a plurality of conductive fibers which has pores.

2. The fuel cell gas diffusion layer according to claim 1, wherein each of the plurality of conductive fibers has a length shorter than a depth of the fluid flow path and shorter than a minimum width of the fluid flow path.

3. The fuel cell gas diffusion layer according to claim 1, wherein:
the conductive wire portion contains binder resin that binds the plurality of conductive fibers to each other, and
a contact angle of the conductive wire portion is 130° or larger.

4. The fuel cell gas diffusion layer according to claim 1, wherein:
the fluid flow path has a width of 0.1 mm to 1.0 mm inclusive at a middle in a depth direction of the fluid flow path, and
each of the plurality of conductive fibers is a carbon nano tube.

5. A fuel cell comprising:
a membrane electrode assembly including an electrolyte film, an anode catalyst layer disposed on one of surfaces of the electrolyte film, and a cathode catalyst layer disposed on the other surface of the electrolyte film;
an anode gas diffusion layer disposed on the membrane electrode assembly at a side of the anode catalyst layer; and
a cathode gas diffusion layer disposed on the membrane electrode assembly at a side of the cathode catalyst layer,
wherein at least one of the anode gas diffusion layer and the cathode gas diffusion layer is constituted by the fuel cell gas diffusion layer according to claim 1.

6. A method for manufacturing a fuel cell gas diffusion layer, the method comprising:
preparing a porous sheet containing at least conductive particles;
forming a layer of conductive fibers on one of main surfaces of the porous sheet; and
deforming the porous sheet and the layer of conductive fibers through heating and pressurization so as to form a porous layer including a groove-shaped fluid flow path on one of main surfaces of the porous layer and so as to form a conductive wire portion extending along the one of the main surfaces of the porous layer and a surface of the fluid flow path, the conductive wire portion being configured by the layer of the conductive fibers which has pores.

7. The fuel cell gas diffusion layer according to claim 1, wherein:
a proportion of the conductive particles in the porous layer is 50 wt % or larger, and
a proportion of the conductive fibers in the conductive wire portion is 70 wt % or larger.

8. The fuel cell gas diffusion layer according to claim 1, wherein a density of the conductive wire portion is smaller than a density of the porous layer.

9. The fuel cell gas diffusion layer according to claim 1, wherein the conductive wire portion is made of a material having a conductivity higher than conductivities of the conductive particles.

10. A fuel cell comprising:
a membrane electrode assembly including an electrolyte film, an anode catalyst layer disposed on one of surfaces of the electrolyte film, and a cathode catalyst layer disposed on the other surface of the electrolyte film;
an anode gas diffusion layer disposed on the membrane electrode assembly at a side of the anode catalyst layer; and
a cathode gas diffusion layer disposed on the membrane electrode assembly at a side of the anode catalyst layer,
wherein at least one of the anode gas diffusion layer and the cathode gas diffusion layer is constituted by the fuel cell gas diffusion layer according to claim 7.
